(19) United States
(12) Patent Application Publication
(10) Pub. No.: US 2014/0034340 A1
(43) Pub. Date: Feb. 6, 2014

(54) Tiller and Bed Former With Dual Belt Drive

(71) Applicant: Eugene W. Walker, JR., Moxee, WA (US)

(72) Inventor: Eugene W. Walker, JR., Moxee, WA (US)

(73) Assignee: NORTHWEST TILLER COMPANY, INC., Yakima, WA (US)

(21) Appl. No.: 13/563,515

(22) Filed: Jul. 31, 2012

(51) Int. Cl. A01B 49/02

(52) U.S. Cl. 172/68; 172/72; 172/184

(57) ABSTRACT

A tiller (100) configured to be pulled by a tractor includes a support structure (110) comprising a hitch assembly (112), a rotor housing (120), and a rear support (114). A rotary tiller assembly (150) is rotatably mounted in the rotor housing. A drive assembly (130) includes a gear box that receives power from a power takeoff and splits the power between left and right belt drives that engage either end of the tiller rotor (151). A bed former assembly (170) extends rearward from the tiller and includes a pan with a converging channel and a distal portion, positioned to receive tilled soil to form a raised bed. Shovel assemblies (190) are disposed on either side of the rotary tiller assembly.

### BACKGROUND

Tillers are known in the art and are used in agriculture for “tillage,” or preparation of soil by agitation such as digging, stirring, and overturning. Tillage using hand tools such as shovels, picks, hoes, and the like is difficult and not well suited to modern farming. Smaller-scale, gas-powered rotary tillers are also well known. For example, in U.S. Pat. No. 3,978,929 Clark discloses a rotor tiller designed for use with a walking attendant for cultivating a swath of ground. However, larger-scale agriculture typically use tillers that are attached to, and powered by, a tractor or similar farm implement. Such tillers are capable of working relatively large tracts in a relatively short period of time.

Tillage may be classified as primary tillage and secondary tillage. Primary tillage (including plowing and rotary tilling, for example) typically refers to deeper agitation of the soil, and secondary tillage (harrowing, for example) refers to a shallower and/or selective working of the soil. Primary tillage, therefore, produces a rougher surface which may require additional working prior to planting, and secondary tillage generally produces a smoother surface to make a good bed for many crops.

A tractor-mounted rotary tiller is disclosed in U.S. Pat. No. 4,386,661, to McCanse et al., which uses the power takeoff (PTO) from a tractor to power the tiller through a gearbox that drives the rotary tiller assembly. More recently, in U.S. Pat. No. 8,181,711, to Fraley et al., a tiller is disclosed having a removable tine rotor, which is mounted on spindles, such that the rotor can be more easily removed from the tiller for repair and the like.

Tractor-powered rotary tillers drive tines through soil, to loosen and agitate the soil, typically to prepare the soil for planting. Agitation of soil requires significant work and power. Moreover, the tiller will typically encounter obstacles, such as rocks, plant matter, and/or other debris in the soil, that may require significant additional power delivery to the tiller rotor. Tillers may incur damage when encountering such obstacles, which can result in significant and expensive downtime for disassembly, repair, and reassembly of the tiller.

Conventional rotary tillers typically produce an uneven surface that is not suitable for planting without further working of the soil. In particular, it is often desirable to provide planting beds that are raised or separated by trenches or footpaths to permit planting, maintenance, and harvesting of the produce.

A tiller assembly is disclosed herein that overcomes many of the disadvantages of prior art tilling assemblies. For example, tillers are disclosed with improved power transfer to the rotor, and that are relatively easy to repair. In a particular embodiment the tiller includes an integral bed former assembly operable to form a raised planting bed while tilling the soil.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A tiller apparatus includes a support structure, a rotor housing assembly supported by the support structure, a rotary tiller assembly rotatably mounted in the rotor housing assembly, a drive assembly that drivably engages the rotary tiller assembly, and a bed former assembly that extends rearward from the rotary tiller assembly. Optionally, the tiller apparatus may include a shovel assembly disposed on either side of the rotary tiller assembly.

In an embodiment, the support structure includes a hitch assembly, preferably a three-point hitch assembly, and a rear support structure that extends behind the tiller assembly. The bed former assembly includes a pan hingedly attached to the rotor housing assembly that defines an inverted channel with a converging portion. An adjustable screw assembly attaches the pan to the rear support structure.

In an embodiment, the drive assembly includes a gearbox that receives power from the tractor PTO and drives left and right belt drive systems that rotatably drive the tiller. The drive pulleys, driven pulleys, and belts are cogged.

In an embodiment, the hitch assemblies include a plurality of beams that extend rearward and support a curved panel that engages oppositely disposed end plates to form the rotor housing.

In an embodiment, the bed former assembly includes a pan defining an inverted channel, with a cylindrical roller rotatably mounted in the channel, and configured to compact the soil during use. The pan may be pivotally attached to the rotor housing, with an adjustment mechanism for adjusting the angle of the pan.

In an embodiment, the rotary tiller assembly includes a rotor that mounts a plurality of tine assemblies having curved tines for tilling the soil. The curved tines may be arranged such that the tines overlap longitudinally to improve the tilling functionality. In a particular embodiment, the tines are fixed to two-part mounting brackets such that pairs of oppositely curved tines are disposed every 120 degrees, and neighboring tine assemblies are rotationally offset such that the tines of one tine assembly are disposed between the tines of neighboring tine assemblies.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an environmental view of a tiller in accordance with the present invention, shown attached to a conventional tractor;

FIG. 2 is an upper-rear perspective view of the tiller shown in FIG. 1;

FIG. 3 is a lower-right-side perspective view of the tiller shown in FIG. 1;

FIG. 4 is a perspective view of the support structure assembly and the rotor housing assembly for the tiller shown in FIG. 1;

FIG. 5 is a perspective view of the shovel assemblies and the rotor housing assembly for the tiller shown in FIG. 1;

FIG. 6 shows the drive assembly for the tiller shown in FIG. 1;

FIG. 7A is a perspective view of the rotary tiller assembly for the tiller shown in FIG. 1; and

FIG. 7B is a fragmentary, partially exploded view of the rotary tiller assembly shown in FIG. 7A.

### DETAILED DESCRIPTION

A particular embodiment of a cultivator or tiller 100 with an integral bed former assembly 170 in accordance with the present invention will now be described with reference to the FIGURES, wherein like numbers indicate like parts.

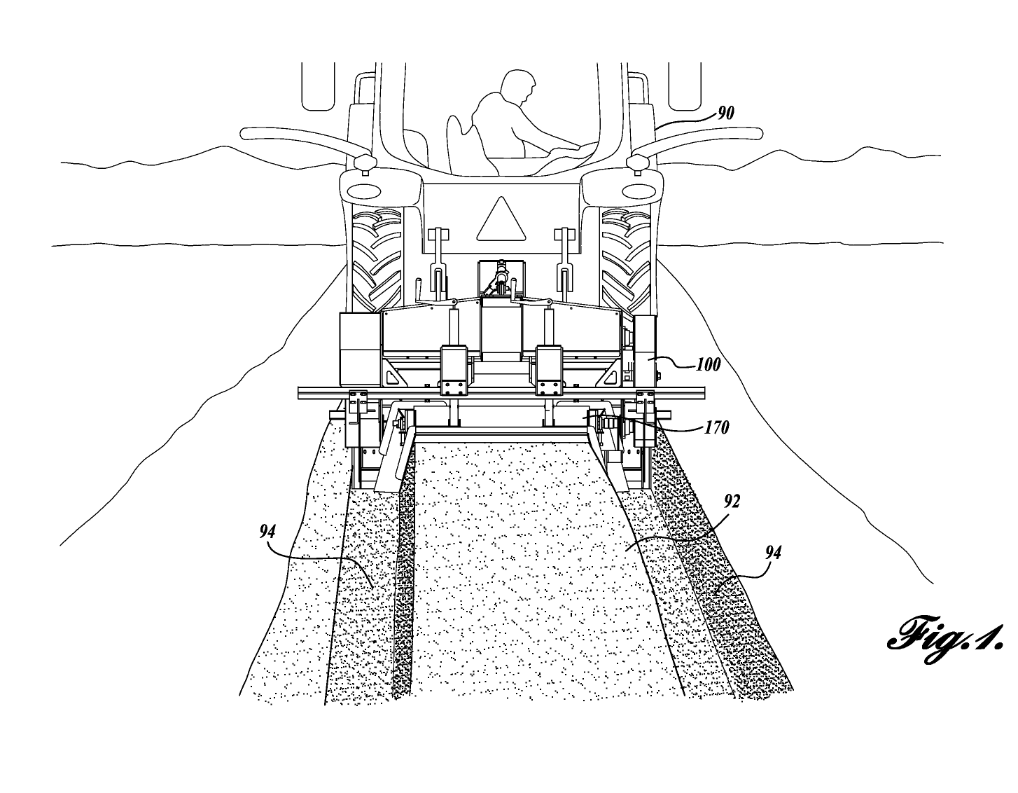

FIG. 1 is a rear view of the tiller 100 with an integral bed former assembly 170 shown attached to a tractor 90, and configured for tilling and preparing a bed 92 suitable for strawberry production, for example. The tiller 100 tills the soil and forms a raised bed in a single pass, with channels 94 on either side of the bed 92.

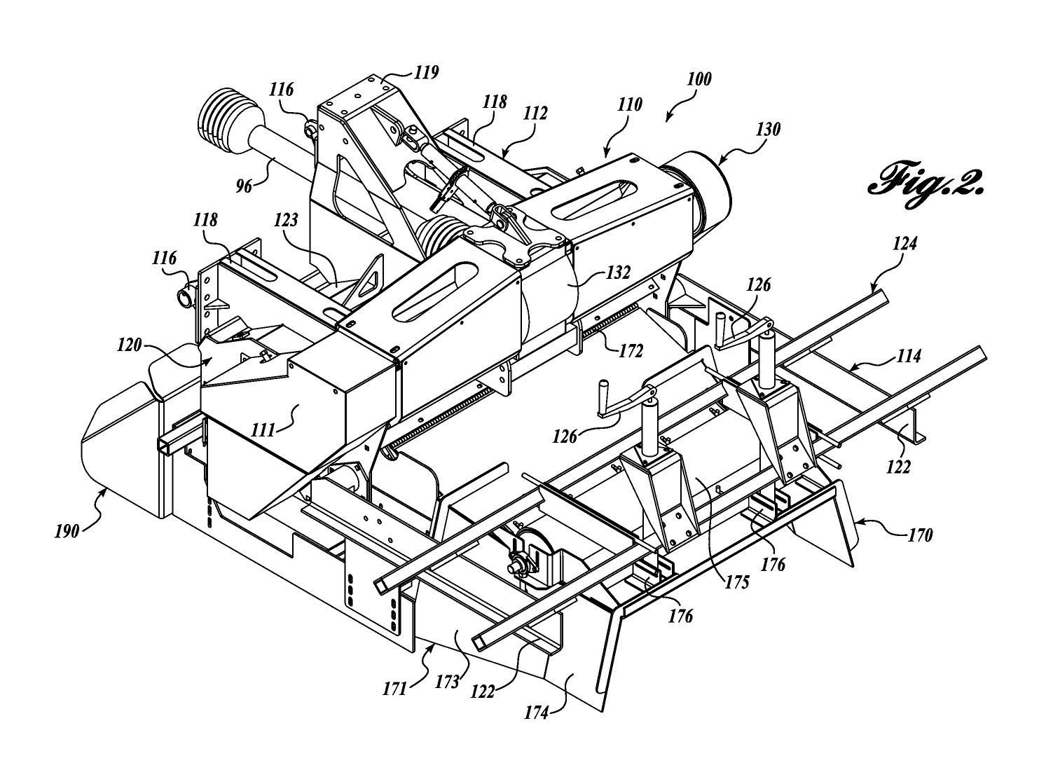

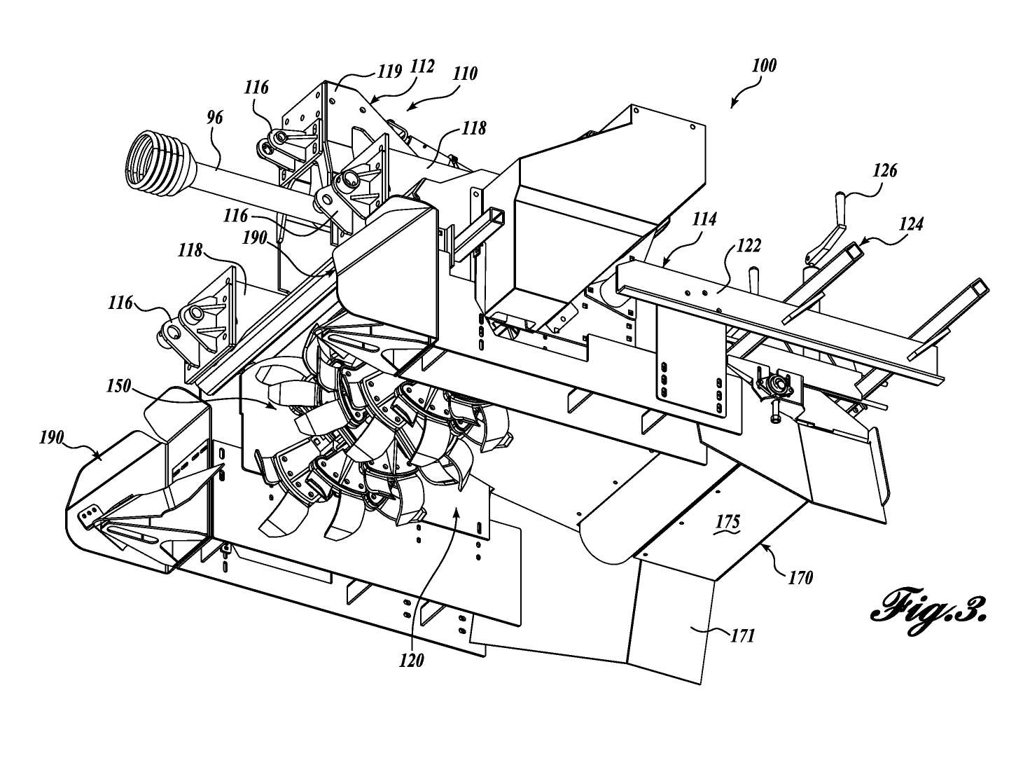

FIG. 2 is a perspective view of the tiller 100 from an upper perspective (a right-side drive housing 111 is shown installed, and a left-side drive housing is removed to show the drive belt assembly described below). FIG. 3 is a perspective view of the tiller 100 from a lower perspective. The tiller 100 in this embodiment is configured to be pulled behind the tractor 90 and is powered by a conventional power takeoff (PTO) from the tractor 90, as indicated by the drive shaft cover 96.

The tiller 100 in this embodiment includes a support structure 110, a drive assembly 130, a rotary tiller assembly 150, outboard shovel assemblies 190, and an adjustable bed former assembly 170.

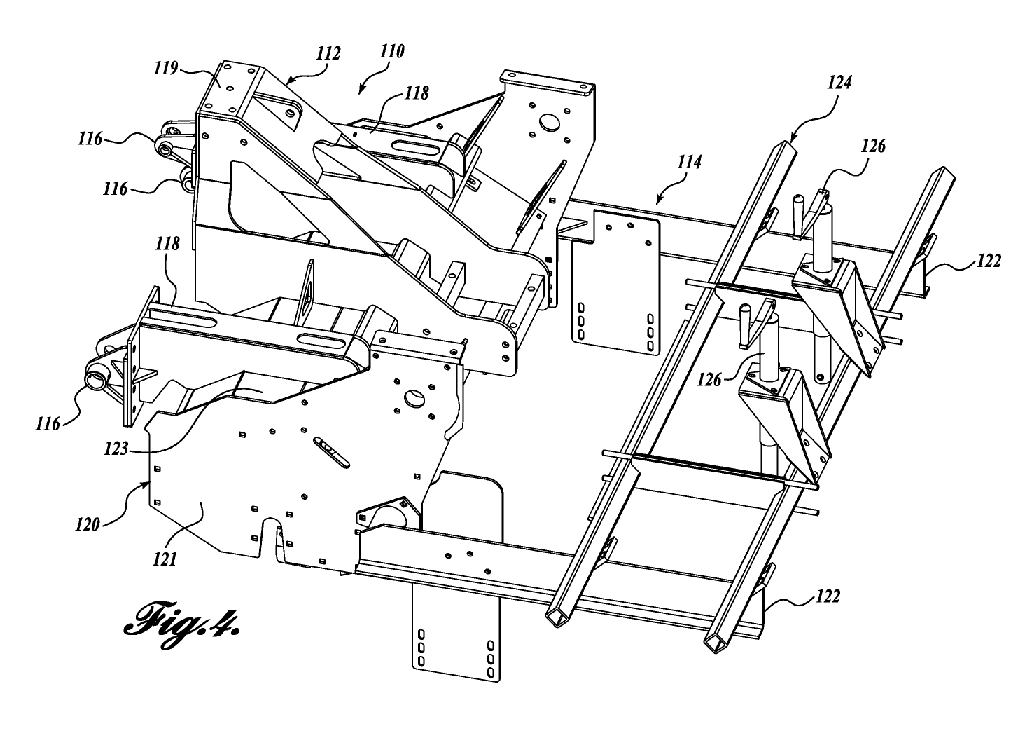

The support structure 110, which is shown in FIG. 4, is a sturdy, substantially rigid assembly that supports the other components of the tiller 100 and reacts the various forces encountered during use. The support structure 110 includes a hitch assembly 112, and a rear support structure 114 that extends rearward from the hitch assembly 112.

The hitch assembly 112 includes three clevis mounts 116 to provide a conventional three-point hitch. The two lower clevis mounts 116 are attached to corresponding support beams 118, and the upper clevis mount 116 is attached to a center mast 119. A rotor housing assembly 120 is attached to the beams 118 and the center mast 119, and is configured to enclose the upper portion of the rotary tiller assembly 150.

The rear support structure 114 includes a pair of parallel beams 122 that are attached to the back of the hitch assembly 112, and extend distally on either side of the bed former assembly 170. A transverse support structure 124 is fixed to an aft portion of the parallel beams 122, and supports a pair of hand-operable jackscrews 126 that allow the user to set the angular position of the bed former assembly 170.

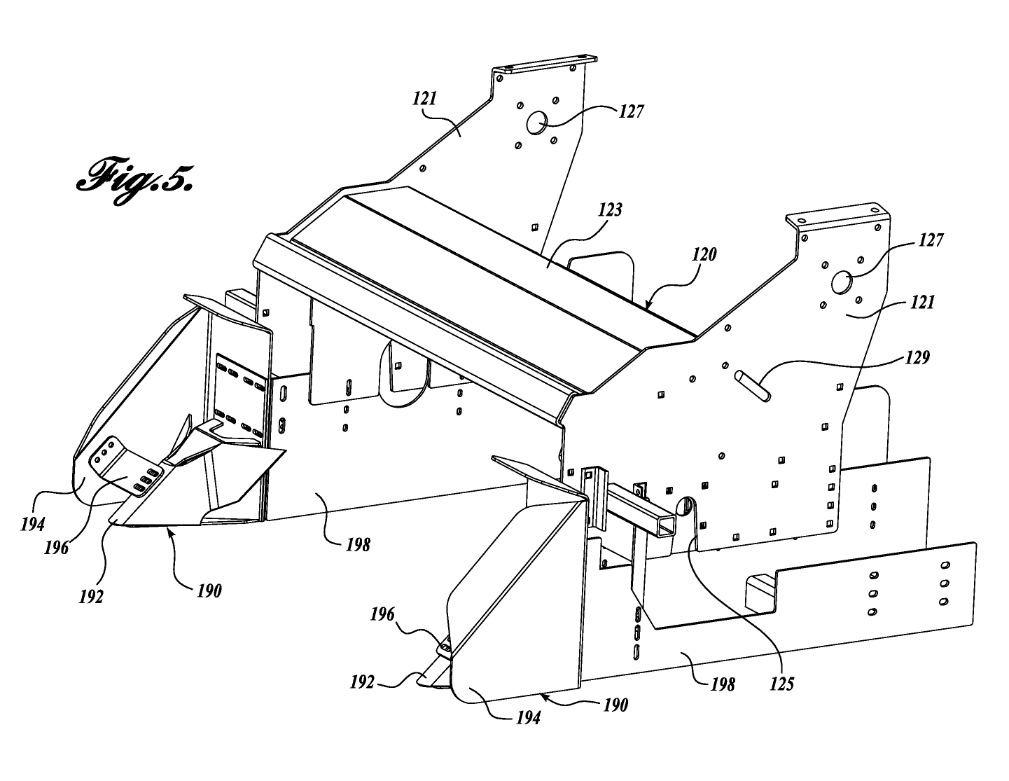

Left and right shovel assemblies 190 are disposed on either side of the tiller 100. The shovel assemblies 190 and the rotor housing assembly 120 are shown in FIG. 5. The shovel assembly 190 includes an anvil or plow-shaped nose portion 192 that extends forward from the base of the tiller 100, and is angled downward such that the shovel assemblies 190 tend to generate trenches during use. A generally L-shaped angled edging guide 194 extends behind the nose portion 192 and outboard of the nose portion 192, with a forward end fixed to the nose portion 192 with a bracket 196. The nose portion 192 and edging guide 194 are attached to a box structure 198 extending rearward from the edging guide 194.

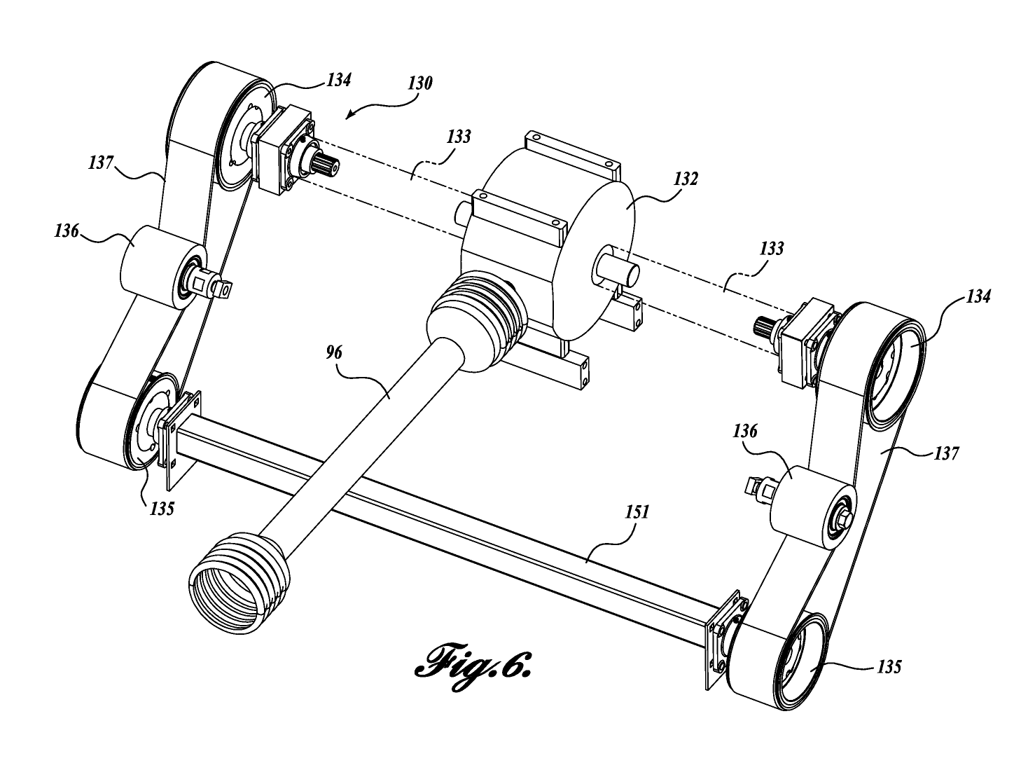

The rotor housing assembly 120 includes oppositely disposed upright plates 121 that engage and support a curved or segmented transverse panel 123. Each of the upright plates 121 define a downwardly open slots 125 for attaching the driven pulley 135 for the tiller rotor shaft 151 (see, FIG. 6), apertures 127 for mounting the drive pulley 134, and a slot 129 for adjustably supporting the tensioner or idler pulley 136, as discussed below.

The drive assembly 130 for the tiller 100 is illustrated in FIG. 6. The power from the tractor PTO is provided by a drive shaft (not shown) that extends through a safety cover 96 to engage a conventional split gearbox 132. The gearbox 132 is configured to split the incoming power between oppositely disposed drive shafts 133 (indicated in phantom). The drive shafts 133 engage oppositely disposed drive pulleys 134 that each drivably engages a driven pulley 135 through a drive belt 137, to turn the tiller rotor shaft 151. In a current embodiment, the drive belt 137 is a timing belt or cogged belt, and the drive pulley 134 and the driven pulley 135 are cogged. A tensioner or idler pulley 136 is also provided.

This novel dual drive belt system, therefore, transmits power from the PTO to both ends of the tiller rotor shaft 151. This configuration provides better power transmission to the tiller rotor shaft 151, which has been found to be very beneficial to tiller applications. The belt system also provides benefits over systems having a hard linkage such as a chain or gear system. For example, if an unexpected obstacle is encountered, such as a large rock or the like, the belt may be designed to fail to protect components that are more difficult to replace. The belt system is more resistant to breakage and is much easier to replace, if needed.

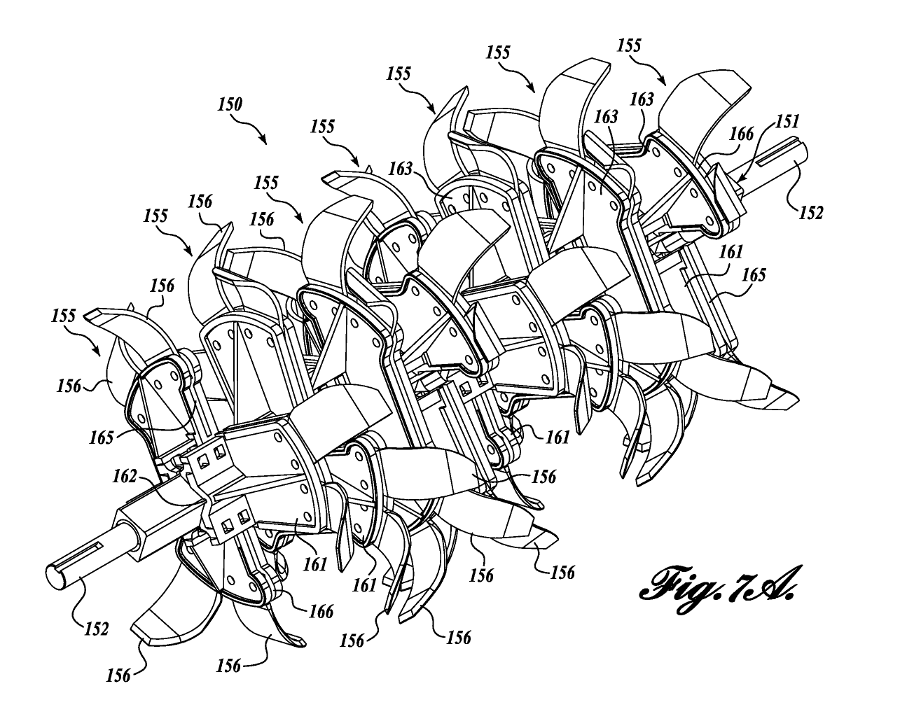

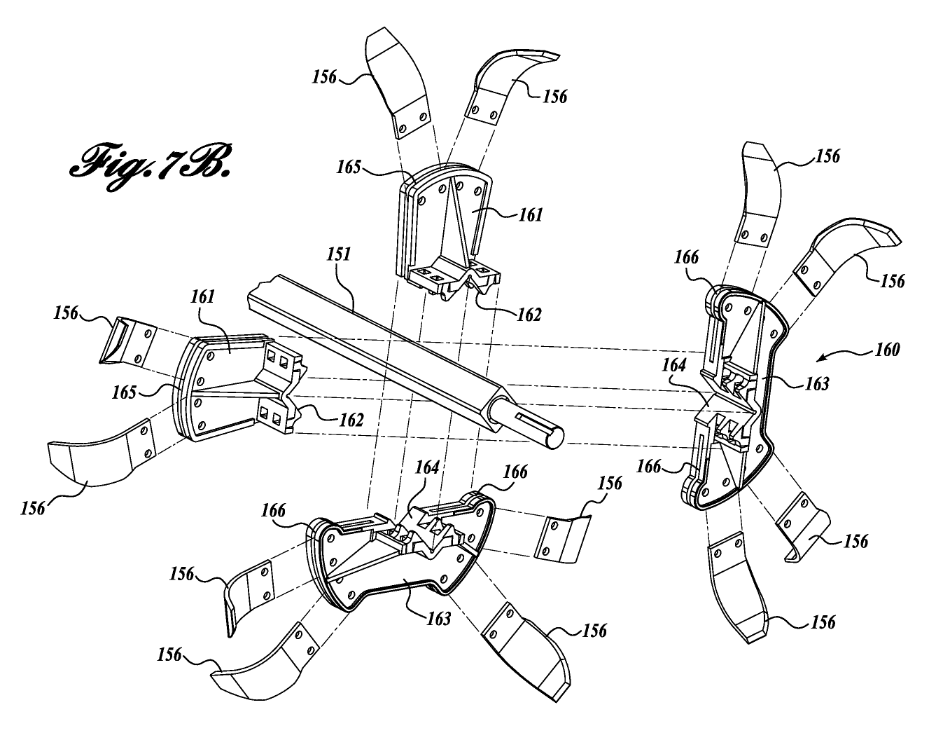

A perspective view of the assembly rotary tiller assembly 150 is shown in FIG. 7A. In the current embodiment, the tiller assembly 150 uses a solid rotor shaft 151 having a square cross-section along most of its length. The solid construction provides better durability and strength over conventional tubular shafts, and allows the shaft 151 to be straightened if it becomes bent. Cylindrical end portions 152 are configured to engage the driven pulleys 135 (FIG. 6).

Tine assemblies 155 are fixedly attached to the shaft 151. In the disclosed embodiment eight tine assemblies 155 are provided, although more or fewer tine assemblies may be used to meet the needs of a particular application. Adjacent tine assemblies 155 are rotationally offset one hundred eighty degrees, as discussed below. Refer also to FIG. 7B, which is a fragmentary exploded view showing two tine assemblies 155 and the tiller shaft 151. (Conventional attachment hardware is not shown throughout, for clarity in the drawings.)

Each tine assembly 155 includes a two-part mounting bracket 160 that rigidly supports three pairs of tines 156. The bracket 160 first part 161 includes an angled corner portion 162 sized to engage two sides of the shaft 151. A slot 165 is configured to receive and retain two tines 156 using suitable attachment hardware (not shown). One end of each tine 156 is inserted into the slot 165 such that the tines curve towards opposite sides of the bracket 160, and the tines 156 are fixedly attached. The second part 163 also includes an angled corner portion 164 that is sized to engage two sides of the rotor shaft 151. Two oppositely disposed slots 166 that are each configured to receive and retain two tines 156, which are also installed to curve in opposite directions.

The first part 161 and the second part 163 are positioned opposite each other on opposite sides of the shaft 151, and attachment hardware (not shown) connects the parts 161, 163, such that the mounting bracket 160 is clampingly fixed to the shaft 151.

Therefore, each tine assembly 155 includes three pairs of tines 156, wherein the tines 156 of each pair curve in opposite directions. The pairs of tines 156 for each assembly 155 are rotationally spaced by 120 degrees in a generally Y-shaped arrangement. Adjacent tine assemblies 155 are mounted to the shaft 151 in opposite orientations, i.e., rotationally offset by 180 degrees. Therefore, the tines 156 for one tine assembly 155 are disposed between the tines of the adjacent assemblies 155.

The tine assemblies 155 are also closely spaced such that the tines 156 of adjacent tine assemblies 155 overlap longitudinally. Therefore, for the longitudinally overlapping portions of the volume defined by the rotating tiller assembly 150 the tines 156 are rotationally spaced by sixty degrees. This tine assembly configuration provides for a very thorough agitation of the soil during use.

Referring again to FIG. 2, the bed former assembly 170 disposed aft of the rotary tiller assembly 150 includes an inverted channel-shaped bed former or pan 171 that is pivotably attached to the back of the rotor housing assembly 120 with a continuous hinge 172. The pan 171 defines a downwardly open channel having an outwardly angled sidewalls. A forward section 173 of the pan 171 is converging, and a rearward section 174 is substantially constant area. The rearward section 174 is adjustably supported by the rear support structure 114 by the two jackscrews 126, which engage brackets 176 fixed to the rear end of the pan 171. Therefore, the user can pivotably adjust the angle of the pan 171 about the pivot defined by the hinge 172.

A cylindrical roller 175 is rotatably mounted near the aft end of the converging forward section 173. In a current embodiment, the cylindrical roller 175 is driven to rotate in the direction of motion of the tiller 100. In a current embodiment the cylindrical roller 175 is hydraulically driven from the tractor hydraulic system. As the tiller 100 is operated the agitated soil forms a raised bed as the converging forward section 173 causes the loosened soil to pile up. The cylindrical roller 175 then partially compacts the soil to prepare it for planting.

To use the tiller 100, it is attached to a tractor 90 using the three-point hitch assembly 112 and a drive shaft connects the tractor PTO to the tiller 100. The tiller 100 is lowered to the tilling position, and if desired the user may adjust the angle of the pan 171. The tiller 100 is pulled in a field, whereby the soil plants and other matter in the soil are tilled and loosened by the rotary tiller assembly 150. The tilled soil is formed into a raised planting bed 92 (FIG. 1) by the pan 171, with channels 94 defined on either side of the bed 92. The raised bed 92 is desirably compacted by the cylindrical roller 175.

While illustrative embodiments have been illustrated and described, it will be appreciated that various changes can be made therein without departing from the spirit and scope of the invention.

1. A tiller and bed forming apparatus comprising:
a support structure comprising a hitch assembly and a rear support structure extending rearward from the hitch assembly;
a tiller housing assembly attached to the hitch assembly;
a rotary tiller assembly having a rotor shaft rotatably supported in the tiller housing assembly, and a plurality of tine assemblies fixedly attached to the rotor shaft;
a belt drive assembly drivably connected to the rotary tiller assembly and configured to receive power from a power takeoff and operable to rotatably drive the rotary tiller assembly;
a pivotable bed former assembly comprising a pan having a proximal converging portion and a distal portion, the pan extending rearward from the tiller housing assembly and adjustably supported by the rear support structure; and
an outboard shovel assembly that is attached to the support structure, wherein the outboard shovel assembly comprises a left shovel disposed to the left of the rotary tiller assembly and a right shovel disposed to the right of the rotary tiller assembly.

2. The tiller and bed forming apparatus of claim 1, wherein the hitch assembly comprises (i) first and second beam assemblies each having a clevis mount fixed to a forward end, and (ii) a center mast having a third clevis mount fixed thereto.

3. The tiller and bed forming apparatus of claim 2, wherein the tiller housing assembly comprises (i) a curved panel that is fixed to the first and second beam assemblies, and (ii) oppositely disposed end plates that are attached to the curved panel.

4. The tiller and bed forming apparatus of claim 1, wherein the rear support structure comprises (i) first and second beams that extend rearward from the hitch assembly, and (ii) a transverse support structure attached to a distal portion of the first and second beams.

5. The tiller and bed forming apparatus of claim 1, wherein the drive assembly comprises (i) a gear box having a power input, (ii) a first output drive shaft that drivably engages a first side of the rotor shaft, and (iii) a second output drive shaft that drivably engages a second side of the rotor shaft.

6. The tiller and bed forming apparatus of claim 5, wherein the first output drive shaft further comprises a first drive pulley that drivably engages a first driven pulley disposed on a first end of the rotor shaft, and the second output drive shaft further comprises a second drive pulley that drivably engages a second driven pulley on a second end of the rotor shaft.

7. The tiller and bed forming apparatus of claim 6, wherein the drive assembly further comprises a first drive belt that connects the first drive pulley with the first driven pulley and a second drive belt that connects the second drive pulley with the second driven pulley.

8. The tiller and bed forming apparatus of claim 1, wherein the bed former assembly comprises a pan having a first end that is pivotably attached to the tiller housing assembly with a hinge.

9. The tiller and bed forming apparatus of claim 8, wherein the pan comprises a forward portion defining a converging channel and a rearward portion that extends distally from the forward portion.

10. The tiller and bed forming apparatus of claim 9, wherein the bed forming apparatus further comprises a roller that is rotatably attached to the pan and that extends through the pan.

11. The tiller and bed forming apparatus of claim 10, wherein the roller is configured to compact soil disposed in the pan.

12. The tiller and bed forming apparatus of claim 8, wherein the bed forming apparatus further comprises an adjusting screw that adjustably attaches a rearward portion of the pan to the rear support structure.

13. The tiller and bed forming apparatus of claim 1, wherein the plurality of tine assemblies each comprise a plurality of curved tines attached to a mounting bracket.

14. The tiller and bed forming apparatus of claim 13, wherein the plurality of tine assemblies are configured such that at least some of the tines on a first tine assembly are disposed between and longitudinally overlapping the tines on a neighboring second tine assembly.

15-16. (canceled)

17. The tiller and bed forming apparatus of claim 1, wherein the left shovel and the right shovel comprise an anvil shaped toe that is configured to dig into the soil during use.

18. A strawberry bed former configured to form a raised bed comprising:
a support structure defining a tiller housing, a left shovel assembly, and a right shovel assembly;
a rotary tiller assembly comprising a rotor shaft rotatably supported in the tiller housing between the left shovel assembly and the right shovel assembly, and a plurality of tine assemblies fixedly attached to the rotor shaft;
a belt drive assembly drivably connected to the rotary tiller assembly and configured to be driven by a power takeoff; and
a bed former assembly comprising a pan having a proximal converging portion pivotably attached to the support structure, and a distal portion.

19. The strawberry bed former of claim 18, wherein the belt drive assembly comprises a gear box configured to receive power from the power takeoff and to distribute the power between a left drive and a right drive, wherein the left drive engages a left end of the rotor shaft and the right drive engages a right end of the rotor shaft.

20. The strawberry bed former of claim 19, wherein the belt drive assembly further comprises left and right cogged drive pulleys that are drivably connected to the gear box, left and right cogged driven pulleys that are fixedly connected to the rotor shaft, and left and right cogged belts that engage the corresponding left and right drive and driven pulleys.

21. The strawberry bed former of claim 18, wherein the bed former assembly further comprises a cylindrical roller rotatably mounted to the bed former pan and configured to compact soil entering the bed former pan.

22. The strawberry bed former of claim 18, wherein the support structure further comprises a hitch assembly and a rear support that extends from the hitch assembly, and an adjustment means for adjustably attaching a distal end of the bed pan to the rear support.

23. The strawberry bed former of claim 18, wherein the plurality of tine assemblies each comprise a plurality of curved tines, and further wherein the tine assemblies are configured such that the curved tines on adjacent tine assemblies overlap longitudinally.

24-25. (canceled)
